(19) United States
(12) Patent Application Publication
(10) Pub. No.: US 2017/0237340 A1
(43) Pub. Date: Aug. 17, 2017

(54) METHOD AND APPARATUS FOR INTRINSIC POWER FACTOR CORRECTION

(71) Applicant: Momentum Dynamics Corporation, Malvern, PA (US)

(72) Inventors: Bruce Richard LONG, Malvern, PA (US); Andrew W. DAGA, Malvern, PA (US)

(21) Appl. No.: 15/518,675

(22) PCT Filed: Oct. 19, 2015
(86) PCT No.: PCT/US15/56204

§ 371 Date: Apr. 12, 2017

Related U.S. Application Data
(60) Provisional application No. 62/065,889, filed on Oct. 20, 2014.

(51) Int. Cl. H02M 1/42; H02J 7/04; H02J 7/02; H02J 50/12; H02M 1/14

(52) U.S. Cl. CPC H02M 1/4258; H02J 50/12; H02M 1/14; H02J 7/025; H02J 7/04

(57) ABSTRACT

A resonant induction wireless power transmission apparatus having intrinsic line power factor correction provides a method of wireless transmission with a near unity power factor, low harmonic distortion load at the line connection point without employing specific power factor correction circuitry. The apparatus provides a transmission frequency inverter operated with a rectified sinusoidal supply voltage instead of a conventional direct current voltage. The resonant induction transfer coil pair is transformed into an impedance inverter by addition of two series connected resonating capacitors of specific value. The impedance inverter raises the secondary side voltage under conditions of light loading and in this way forces line frequency source current and secondary side load current to be proportional, thereby maintaining near unity line load power factor and low harmonic current distortion.

### CROSS-REFERENCE TO RELATED APPLICATIONS

The present application claims priority to U.S. Provisional Patent Application No. 62/065,889, filed Oct. 20, 2014. The contents of that application are hereby incorporated by reference.

### TECHNICAL FIELD

The invention relates to the transmission of electrical energy by means of resonant induction. More specifically, the invention relates to a method of wireless transmission that provides a near unity power factor, low harmonic distortion load at the line connection point without employing specific power factor correction circuitry. Instead, the apparatus described herein provides a low harmonic distortion, near unity power factor without the need for a specific power factor correction stage thereby reducing component cost, apparatus size, and power conversion losses.

### BACKGROUND

Inductive power transmission has many important applications spanning many industries and markets. Although the disclosure contained here contemplates the use of this invention to applications requiring relatively high power (in excess of 100 watts), the potential list of power applications is not limited and this invention can be applied to a wide range of power requirements.

FIG. 1 shows a conceptual representation of a prior art resonant inductive power transmission system 10. As illustrated, a source of alternating, line frequency electrical energy is provided on AC line 12 and converted into direct current with a line frequency rectifier 14 and shunt capacitor ripple filter 16. A DC-AC inverter 18 converts the direct current energy into high frequency alternating current which is applied by means of a resonating network 20 to the primary side induction coil 22. Typical operating frequencies are in the range of 15-50 kHz.

Magnetic coupling between the primary side induction coil 22 and the secondary side induction coil 24 transfers primary side energy to the secondary side where it is rectified by high frequency rectifier 26, ripple filtered by ripple filter 28 and used to charge a remotely located battery 30. A resonating network 32 resonates the secondary side induction coil 24 thereby enabling maximum current flow and maximum energy transfer.

The nature of the load presented to the AC line connection in the circuit of FIG. 1 is determined by the line rectifier—shunt ripple filter capacitor combination. In operation, the line rectifier current is zero unless the instantaneous rectified line voltage exceeds the shunt capacitor voltage. This means that the rectifier current is not sinusoidal but is instead a narrow pulse that occurs just before the line voltage sinusoid reaches its maximum value. Because the rectifier current is a narrow pulse instead of a sinusoid, it contains considerable harmonic content. The associated line frequency harmonic currents are harmful to electric power distribution components and also to other loads connected to the distribution system and are for that reason restricted to low amplitude by utility or government regulation.

Another difficulty is the fact that the line frequency rectifier current peak occurs before the line frequency voltage maximum. This means that the fundamental harmonic component of the line frequency rectifier current pulse leads the line frequency voltage sinusoid creating an undesirable leading current factor which is also subject to regulatory restrictions. Increasing the capacitance of the shunt line frequency ripple filter capacitor 16 reduces the magnitude of the direct current line frequency ripple but also undesirably increases the magnitude and decreases the width of the rectifier current pulse, thereby increasing undesirable line frequency harmonic distortion and unacceptable line power factor.

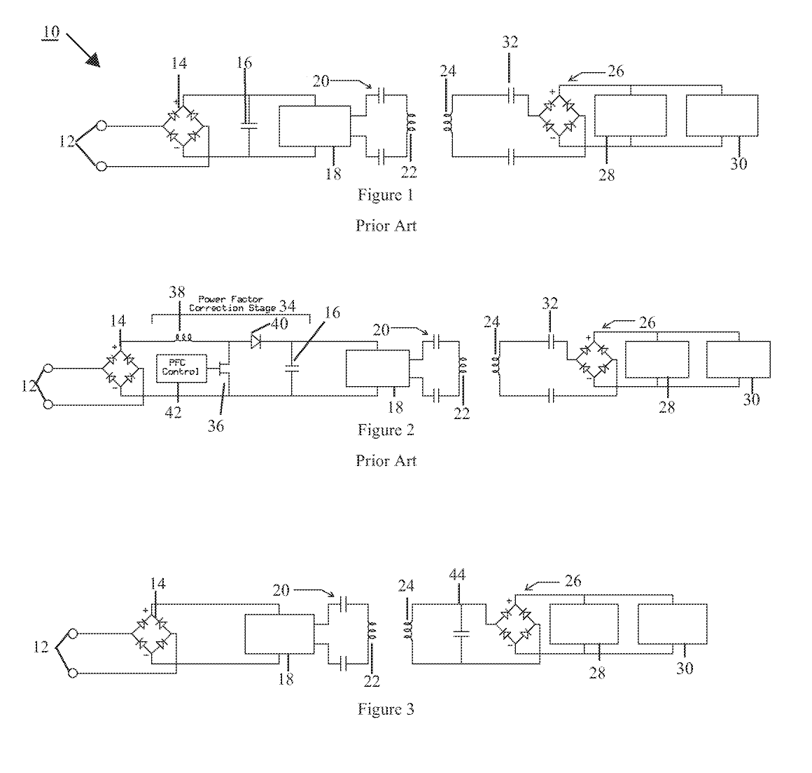

The problem then is how to convert line frequency alternating current into direct current while drawing an in-phase, sinusoidal current from the line voltage source. FIG. 2 shows the conventional solution to this problem, namely, the addition of a power factor correction stage 34. Note that power factor correction in this usage implies both the elimination of rectifier created line frequency harmonic distortion as well as alignment of line frequency voltage and current sinusoids.

The power factor correction stage 34 shown in FIG. 2 consists of a DC-to-DC boost converter although buck and boost-buck converters topologies can be employed as well. A shunt switching device depicted in FIG. 2 as a shunt field effect transistor 36 controls inductor current and therefore AC line current by means of pulse duration. When the shunt transistor 36 is on, inductor current ramps up at a rate proportional to the instantaneous rectified line voltage. Energy stored in the inductor 38 is dumped into the shunt filter capacitor 16 through the series diode 40 when the shunt transistor 36 turns off. A control circuit 42 monitors the rectified line current and continuously adjusts the transistor conduction intervals such that the rectified line current remains proportional to the line voltage. In this way, the line frequency rectifier current is made to be half-cycle sinusoidal and proportional to the line voltage amplitude, harmonic distortion is forced to zero, the power factor is forced to unity, and the DC-AC inverter supply voltage is held essentially constant.

However, there are at least two distinct disadvantages to the conventional method of power factor correction depicted in FIG. 2. Namely, the added power conversion stage increases the cost and the volume of the apparatus and also introduces unwanted energy conversion losses. It is desired to provide a near unity power factor, low harmonic distortion load at the line connection point in a resonant inductive power transmission system without employing such specific power factor correction circuitry. The invention addresses this need in the art.

### SUMMARY

The invention addresses the above mentioned limitations of the prior art by changing the operating parameters of the resonant induction wireless power apparatus so that it intrinsically provides a low harmonic distortion, near unity power factor line load without the need of an additional energy conversion power factor correction. The post-rectifier, line frequency ripple filter, and shunt capacitor of conventional circuits are eliminated and the DC-to-AC inverter is powered not by smoothed, constant value DC voltage but by a half-sinusoidal voltage derived from the full wave rectification of the line sinusoid.

In an exemplary embodiment, the envelope of the high frequency rectangle wave developed by the DC-AC inverter is no longer constant but varies continuously in a half-sinusoidal fashion. The conventional transmission coil pair is combined with resonating capacitors with values specifically selected such that the resonant transmission coil pair becomes a resonant impedance inverter having 90 degrees of transmission phase shift that forces the system load current magnitude, and therefore the AC line current, to be proportional and in phase with the AC line voltage, thus ensuring near unity AC load power factor and low AC line harmonic current content.

On the secondary side of the wireless power transmission coil pair, a rectifier rectifies the transmission frequency sinusoid. A post-rectifier filter removes the inverter frequency ripple and delivers line frequency, half-sinusoid current to the constant DC voltage load. In a three phase AC line source embodiment, the current delivered to the load is the sum of three rectified sinusoids offset from each other by 120 degrees and therefore has reduced line frequency ripple.

In the exemplary embodiment, the invention provides an apparatus that maintains near unity AC line power factor and low AC line harmonic current content. The system includes, on the transmission side, a line frequency rectifier not followed by a line frequency ripple filter, a DC-to-AC inverter that inverts the rectified AC line frequency to an envelope modulated high frequency rectangular waveform with an amplitude that varies continuously in a half-sinusoidal fashion, a transmission coil pair that is combined with resonating capacitors with values specifically selected such that the resonant transmission coil pair becomes a resonant impedance inverter having 90 degrees of transmission phase shift, and a primary side induction coil. On the receiving side, the system includes a transmission frequency rectifier and associated transmission frequency ripple filter that provides half-sinusoidal, non-alternating DC current to the receiving side load.

In another exemplary embodiment, the invention is used in applications where the power flows from a DC power source to an AC load. In such an embodiment, the intrinsic power factor correction apparatus includes a DC power source, a shunt ripple filter capacitor that provides line frequency ripple filtering of an output of the DC power source, a DC-to-AC inverter that converts a line frequency ripple filtered DC voltage from an output of the shunt ripple filter capacitor to an output square wave voltage, an impedance inverter that converts the output square wave voltage to a sinusoidal wave at a frequency of the DC-to-AC inverter that is envelope modulated by a line frequency sinusoid to form a bipolar sinusoidal envelope, a secondary side rectifier that converts the bipolar sinusoidal envelope into a unipolar half-sinusoidal envelope, a de-rectification network that inverts a polarity of every other cycle of the unipolar half-sinusoidal envelope to generate a sinusoidal waveform, and an AC load that receives the sinusoidal waveform. As in the case of the AC source and DC load, the impedance inverter raises a secondary side voltage under conditions of light loading so as to force line frequency source current from the DC power source and a current at the AC load to be proportional so as to maintain near unity line load power factor and low harmonic current distortion. In an exemplary embodiment, this is accomplished by using a Terman impedance inverting network as the impedance network so as to provide a voltage transformation that varies with an instantaneous load voltage at the secondary side of the Terman impedance inverting network. A ripple filter network also may be provided to remove high frequency ripple from the unipolar half-sinusoidal envelope before it is applied to the de-rectification network. The de-rectification network itself may include power semiconductor switches in a half wave or full wave bridge configuration.

In yet another embodiment, a three phase AC grid load is accommodated using three independent DC-to-AC inverter strings where each string drives one of the three AC constant voltage loads that together constitute an AC three phase constant voltage load. An isolation transformer may be used in each string to provide galvanic isolation between the DC power source and the AC load. Also, the DC power source may include three equal voltage independent DC power sources or three DC source nodes may be tied together and fed by a single DC power source.

### DETAILED DESCRIPTION OF DRAWINGS

The foregoing and other beneficial features and advantages of the invention will become apparent from the following detailed description in connection with the attached figures, of which:

FIG. 1 is a conceptual representation of a prior art resonant induction wireless power transfer system without power factor correction.

FIG. 2 is a conceptual representation of a prior art resonant induction wireless power transfer system with added power factor correction circuitry.

FIG. 3 is a conceptual representation of an embodiment of the invention.

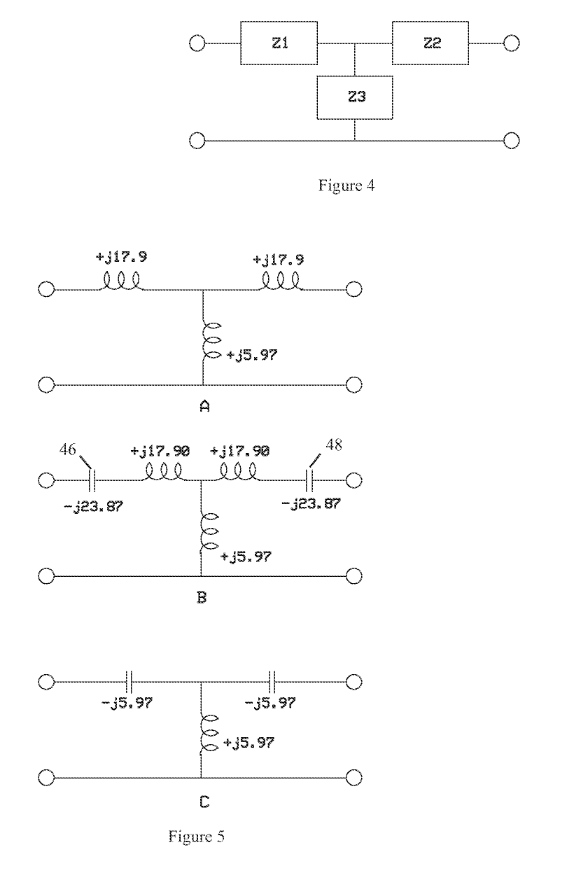

FIG. 4 is a representation of a Terman Tee configuration impedance matching network.

FIG. 5 shows the conversion of a coupled inductor Tee wireless power coil pair equivalent circuit into a resonant impedance inverter.

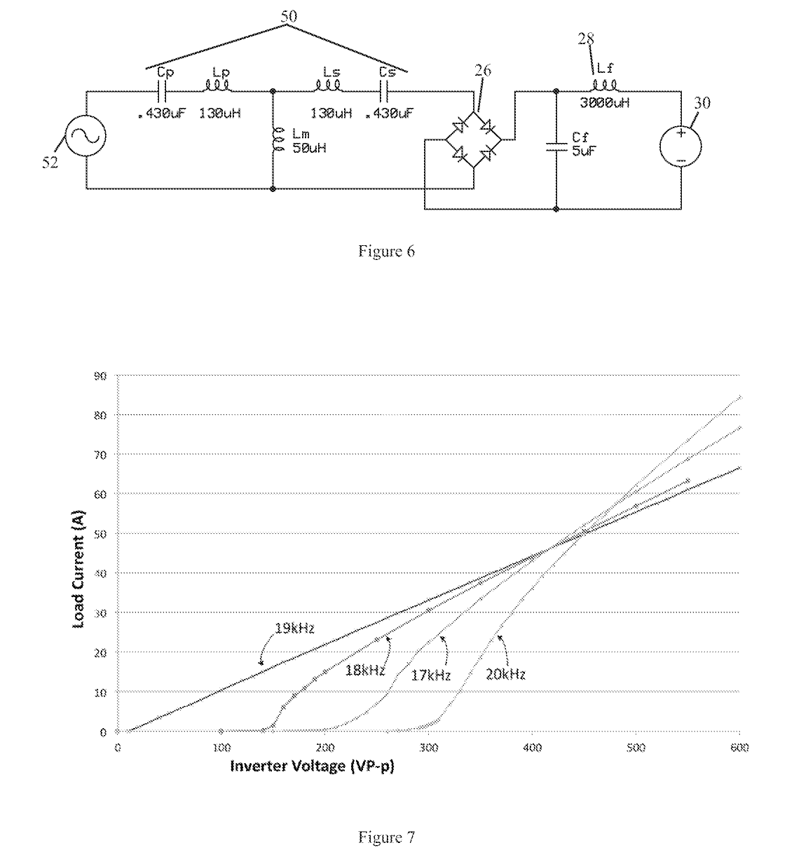

FIG. 6 is schematic diagram of a circuit used for computer circuit analysis of the embodiment of FIG. 3.

FIG. 7 is a graph showing linear results of spice stimulation generated by computer modeling of the load current versus inverter source voltage, at resonance and off resonance.

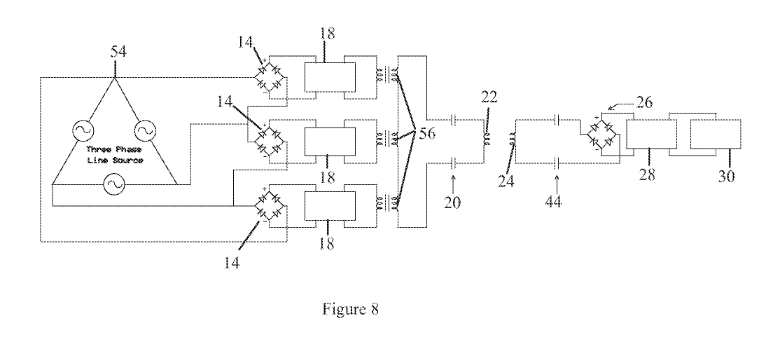

FIG. 8 is a conceptual representation of the application of the invention to three phase line frequency sources using three isolated inverters and inverter output voltage summation.

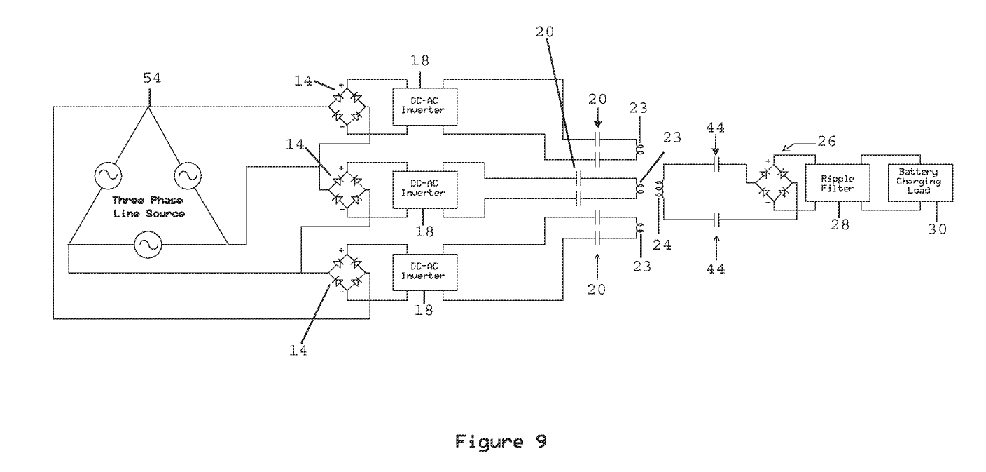

FIG. 9 illustrates an alternative embodiment with the summation transformer of FIG. 8 replaced by a primary side induction coil implemented as three independent, co-located, induction coils sharing a common magnetic core.

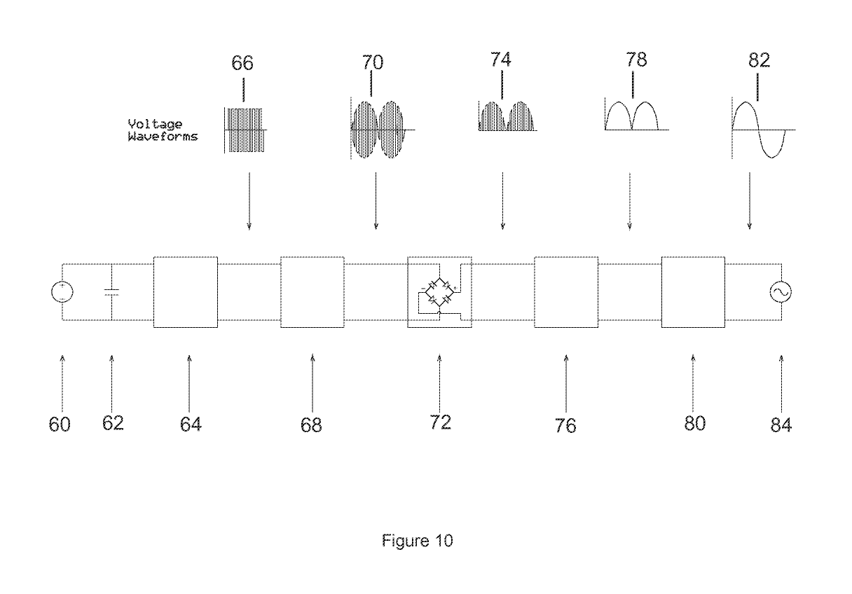

FIG. 10 illustrates a conceptual block diagram and associated voltage waveforms for a DC-to-AC inverter based useful for applications in which power flows instead in the opposite direction from DC-source to ac-load with the apparatus providing a near unity power factor AC source.

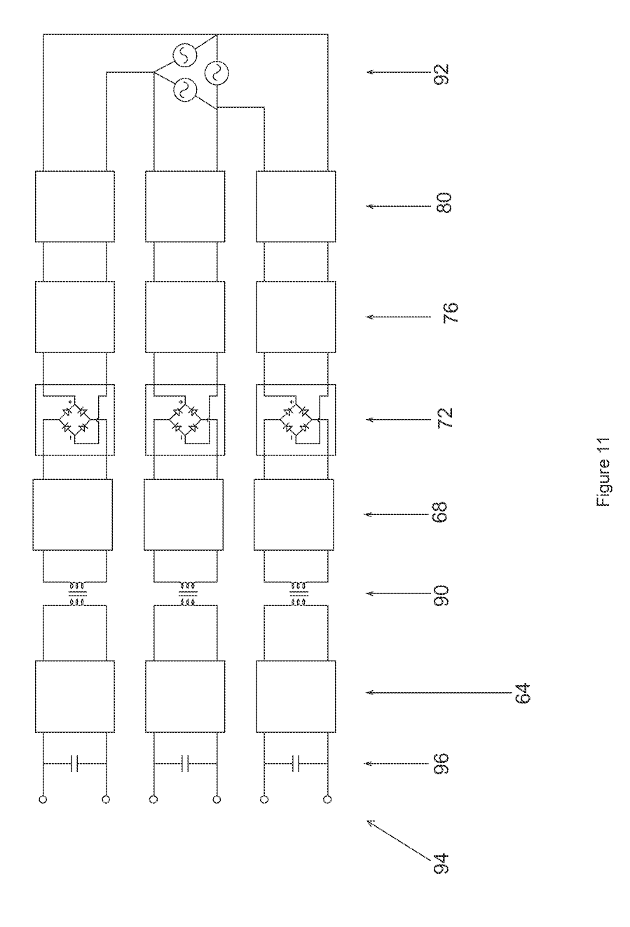

FIG. 11 illustrates an embodiment for accommodating a three phase AC grid load using three independent DC-to-AC inverter strings as in FIG. 9, where each string drives one of the three AC constant voltage loads that together constitute an AC three phase constant voltage load.

### DETAILED DESCRIPTION OF ILLUSTRATIVE EMBODIMENTS

The present invention may be understood more readily by reference to the following detailed description taken in connection with the accompanying figures and examples, which form a part of this disclosure. It is to be understood that this invention is not limited to the specific products, methods, conditions or parameters described and/or shown herein, and that the terminology used herein is for the purpose of describing particular embodiments by way of example only and is not intended to be limiting of any claimed invention. Similarly, any description as to a possible mechanism or mode of action or reason for improvement is meant to be illustrative only, and the invention herein is not to be constrained by the correctness or incorrectness of any such suggested mechanism or mode of action or reason for improvement.

A detailed description of illustrative embodiments of the present invention will now be described with reference to FIGS. 3-11. Although this description provides a detailed example of possible implementations of the present invention, it should be noted that these details are intended to be exemplary and in no way delimit the scope of the invention.

As will now be explained, the system described herein and shown in FIG. 3 is explained in the context of a resonant induction wireless battery charging apparatus, although it will become apparent to those skilled in the art that the invention has numerous other applications. It will be appreciated by those skilled in the art that the embodiment of FIG. 3 departs from conventional resonant induction wireless battery charging practice in a number of ways. For example, battery charging current is not constant; it varies in a half-sinusoidal or rectified sinusoidal fashion. In this way, battery charging current is proportional to and in phase with a single phase AC line voltage sinusoid source. The secondary side rectifier load impedance is understood to be non-linear, behaving as a constant voltage load with a small Thevenin resistance. No current flows through the secondary side rectifier unless the applied alternating voltage exceeds the battery terminal voltage. The primary side, secondary side induction coil pair 22, 24 and associated resonating capacitors 20, 44 can be configured to function as a voltage step up network under conditions of light loading. Such resonant LC networks are intrinsically high Q under light load conditions and large voltage step up ratios are possible at the resonant frequency.

During the period of no rectifier current flow, the resistive losses in the secondary side resonant circuit are zero, the instantaneous loaded Q is very high, and significant voltage transformation occurs. Under such instantaneous no-load conditions, the resonant circuit output voltage applied to the secondary side rectifier 26 increases until it exceeds the battery terminal voltage and battery current begins to flow. With proper design, the secondary side battery charging current can be made to flow throughout the duration of the line frequency half-cycle and be proportional to the absolute value of the AC line voltage, thereby presenting a low distortion, unity power factor load to the AC line frequency source without using a specific power factor correction stage.

The invention described herein makes use of an impedance inverter that provides a voltage transformation that varies continuously as a function of the instantaneous battery terminal impedance as required to maintain proportionality between the line current and the line voltage over each line half-cycle. As known to those skilled in the art, an impedance inverter is a bi-directional two-port network in which a low impedance applied to one port creates a high impedance at the other port.

A λ/4 transmission line transformer is an example of an impedance inverter implementation. Impedance inverter realizations are not limited to transmission line implementations. For example, there are multiple, lumped circuit configurations including ladder circuit networks. The invention makes use of a three element Tee impedance matching network as described by Terman (Radio Engineers handbook, First Edition, McGraw Hill, 1943) and shown in FIG. 4. Terman impedance matching network reactances are found as follows:

$${Z}_{1} = - j \frac{{R}_{1} Cos β - \sqrt{{R}_{1} {R}_{2}}}{Sin β}$$

$${Z}_{2} = - j \frac{ {R}_{2} Cos β - \sqrt{{R}_{1} {R}_{2}} }{Sin β}$$

$${Z}_{3} = - j \frac{\sqrt{{R}_{1} {R}_{2}}}{Sin β}$$

where R₁ is the two port source impedance, R₂ is the two port load impedance, and β is the phase shift through the network in radians. The Tee impedance matching network functions as an impedance inverting network when designed to have a 90 degree, |β|=π/2 transmission phase shift. For 1131=π/2 the reactance design equations simplify to:

Z₁=Z₂=−Z₃=−j\sqrt{R₁R₂}

In an exemplary embodiment, the values of R₁ and R₂ are not constant but vary continuously during each rectified half-cycle. The geometric product \sqrt{R₁R₂} is constant and the three network reactances have equal magnitude. This observation is used in the subsequent design of the resonant induction coil matching networks.

FIG. 5 shows how a resonant induction wireless power coil pair can be transformed into a resonant Terman impedance inverter. FIG. 5A shows the wireless power coil pair equivalent circuit of a wireless power transmission coil pair having a coupling coefficient of 0.385 at 19 kHz. The primary and secondary side winding inductances of 130 μH and the mutual inductance of 50 μH have reactances of +j17.9 and +j5.97, respectively, at 19 kHz.

In FIG. 5B, resonating capacitors 46, 48 are added to the network series arms of the equivalent circuit of FIG. 5A. The reactance is selected to completely cancel the reactance of the series inductors Z1, Z2 at 19 kHz and to add an additional series capacitive reactance with the same magnitude as the reactance of the shunt, mutual inductance element Z3 also at 19 kHz. The resulting network in FIG. 5C is an impedance inverting two-port equivalent circuit incorporating a wireless power transfer, coupled inductor pair.

The impedance inverting network of FIG. 5C reduces or eliminates inductive wireless power transfer line current harmonic distortion as follows. Just after the line voltage zero-crossing, the magnitude of the rectified line voltage and the magnitude of the inverter voltage output is small. Rectified current provided to the vehicle battery 30 is zero or very small. The impedance on the secondary side of the Terman impedance inverter is very high; therefore, the impedance on the primary side of the impedance inverter is very low. The impedance inverter sees a low impedance load and supplies substantial primary side current. The secondary side voltage increases until it exceeds the battery voltage. Battery charge current starts to flow, the impedance seen by the inverter increases, and the system stabilizes with moderate line current, moderate inverter current, and moderate battery charging current.

Near the peak of the line voltage cycle, the magnitude of the rectified line voltage and the magnitude of the impedance inverter voltage output is large. Rectified current provided to the vehicle battery is large as well. The impedance on the secondary side of the Terman impedance inverter is low; therefore, the impedance on the primary side of the impedance inverter is relatively high. The compensational action of the impedance inverter makes the line current and the battery charging current proportional to the magnitude of the line voltage, exactly the condition required for unity power factor and zero harmonic distortion. A conventional line filter network may be used to suppress inverter switching frequency transients.

FIG. 6 shows a schematic of an electronic circuit representing a resonant induction wireless power apparatus of the type illustrated in FIG. 3 for which the transfer coil pair 22, 24 has been converted into a resonant impedance inverter following the method outlined in FIG. 5 that was subjected to time domain computer circuit analysis. The mutually coupled, wireless power induction coils, represented by their equivalent Tee circuit having primary and secondary side winding inductances of 130 μH and a mutual inductance of 50 μH, is transformed into a resonant impedance inverting network 50 following the method described with respect to FIG. 5. The AC voltage source 52 represents the output voltage of the primary side inverter 18. The secondary side high frequency rectifier 26 and associated high frequency ripple current filter 28 are shown. The secondary side battery charging load 30 is represented by a direct current voltage source having a small Thevenin resistance representing battery internal resistance.

The inverter output voltage amplitude varies in proportion to the rectified, but not filtered, line frequency voltage. In order to determine the load current as a function of the inverter voltage, a computer simulation was conducted. Time domain circuit simulation was conducted for multiple values of inverter output voltage ranging from zero volts to the peak value of the rectified line voltage. The corresponding load current is graphed in FIG. 7 as a function of the inverter, rectified sine supply voltage.

As shown in FIG. 7, with the AC voltage source frequency set to 19 kHz, the network resonant frequency, battery charging current is linear and proportional to the inverter source voltage. It is important to note battery charging current linearity is maintained even for line source voltages much less than the battery open circuit terminal voltage, a consequence of the voltage transformation properties of a resonant circuit when lightly loaded. The linear curve of FIG. 7 shows the desirable condition of secondary side load current, and therefore inverter supply current and line current being proportional to line voltage, a condition that insures low levels of line frequency harmonic distortion and unity line frequency power factor. When operated above and below the impedance inverter resonant frequency, at 17, 18 and 20 kHz as indicated on FIG. 7, the line voltage/line current relationship is no longer proportional at low line voltages resulting in line current harmonic distortion and degraded line power factor. When operated at the impedance inverter resonant frequency, current varies in a half-sinusoidal or rectified sinusoidal fashion.

Conventionally, battery charging is mediated by a battery management system that monitors and controls battery charging current and maximum battery voltage as well as other relevant parameters such as temperature, sometimes for the battery as a whole but also for individual cells. In current practice, battery/cell management systems require the use of DC charging current and will likely malfunction in the presence of half-sinusoidal charging current. This difficulty is eliminated by modifying the battery management system to respond to the RMS charging current instead of the average or peak measurement methodology employed conventionally.

Effective battery charging requires charging current magnitude be altered according to the battery state of charge as controlled by the battery charging algorithm. In an exemplary embodiment of the invention, maximum battery charging current magnitude is set by the design of the impedance inversion network and by the magnitude of the rectified, half-sinusoidal line voltage that supplies the inverter 18. Further control (reduction) of battery charging current is obtained by pulse width modulation of the inverter 18, by inverter pulse phasing, by inverter pulse dropping and by active control of the secondary side rectifier 26. These control methods employed individually or in combination enable effective control of charging current magnitude while maintaining low harmonic distortion, near unity power factor.

While low to medium power wireless power systems operate from single phase power connections, high power systems generally require a three phase connection. Even though a rectified single phase sinusoid source has a large ripple component, the sum of three rectified sinusoidal sources, with each sinusoid displaced by 120 degrees, is much smaller. Reduced charging ripple current is sometimes desirable for compatibility with battery management system circuitry and for reduction of the peak to average charging current ratio in order to limit battery resistive losses during fast charging.

FIG. 8 shows an embodiment of the invention implemented with a three phase line voltage source 54. Each phase has a separate rectifier 14 and inverter 18. The three inverters switch synchronously and the inverter outputs are combined by a summing transformer 56 that can be three physically independent transformers or a single transformer with six windings on a common core with three phase partial flux cancellation allowing more efficient use of the core material. The summation transformer 56 also provides galvanic isolation from the AC line. Filters on the three phase lines (not shown in FIG. 8) reject inverter switching frequency components resulting in a new unity, low harmonic distortion three phase load. As in prior art FIG. 1, resonating network 20 connects the inverters 18 to the primary side induction coil 22. Magnetic coupling between the primary side induction coil 22 and the secondary side induction coil 24 transfers primary side energy to the secondary side where it is rectified by high frequency rectifier 26, ripple filtered by ripple filter 28 and used to charge a remotely located battery 30. A resonating network 44 resonates the secondary side induction coil 24 thereby enabling maximum current flow and maximum energy transfer.

FIG. 9 shows an alternative embodiment of FIG. 8 where the summation transformer 56 is replaced with the primary side induction coil 22 implemented as three independent, co-located, induction coils 23, sharing a common magnetic core with a secondary side induction coil that is connected to the secondary side rectifier. A separate DC-AC inverter 18 and associated line frequency rectifier 14 drives each of the three primary coils through resonating networks 20. Power summation then occurs as the summation of primary coil flux fields such that dedicated combining transformers 56 are not required. Those skilled in the art will appreciate that the embodiment of FIG. 9 eliminates the size, weight and cost of the combining transformers at the cost of adding two primary coils and two sets of resonating capacitors.

The power factor correction action of a Terman impedance inverter network as described herein can be advantageously employed in apparatus other than resonant induction wireless power transfer systems. Such applications include:

Wired—as opposed to wireless-battery charging;

Metal plating;

Electro-chemical processing such as electrolysis;

Induction heating;

Alternating current welding;

Gaseous discharge processes including fluorescent and arc lighting; and

Any other application providing direct current derived from an alternating current source to loads that can tolerate full wave rectified sinusoidal direct current.

In power factor control of wireless induction power transfer, the Terman impedance inversion network is absorbed into the Tee equivalent circuit of the wireless transfer, mutually coupled, air core coil pair, where one element of the Tee equivalent circuit is the mutual inductance. Those skilled in the art will appreciate that in non-wireless power transfer applications, the impedance inversion network can implemented at three discrete, non-mutually coupled components giving a significant increase in design flexibility.

In the applications discussed above, power flows from AC-source to DC-load with the apparatus providing a near unity power factor load to the AC source. The teachings of the invention apply equally to applications in which power flows instead in the opposite direction from DC-source to AC-load with the apparatus providing a near unity power factor AC source. A reversed power flow apparatus finds application as inverters feeding DC power from alternative energy sources such as photovoltaic panels and wind generators into the 50 or 60 Hz utility grid.

FIG. 10 illustrates a conceptual block diagram and associated voltage waveforms for a DC-to-AC inverter system useful for applications in which power flows instead in the opposite direction from DC-source to AC-load with the apparatus providing a near unity power factor AC source. As illustrated, the circuit of FIG. 10 includes DC power source 60 followed by a shunt ripple filter capacitor 62 that provides line frequency ripple filtering. The line frequency ripple filtered DC voltage is applied to a high frequency DC-to-AC inverter 64. High frequency in this context means high with respect to the line frequency. The output square wave voltage, 66, is applied to the input of a Terman impedance inverting network 68 that provides a voltage transformation that varies with the instantaneous load voltage at the far side of the impedance inversion network.

The waveform 70 at the output of the impedance inversion network 68 is a sinusoidal wave at the DC-to-AC inverter frequency, envelope modulated by a line frequency sinusoid. A high frequency rectifier 72 converts the bipolar sinusoidal envelope into a unipolar, half-sinusoidal envelope 74. A high frequency ripple filter network 76 removes the high frequency ripple giving a ripple free, line frequency half-sinusoidal waveform 78. A derectification network 80 including power semiconductor switches in a half wave or full wave bridge configuration inverts the polarity of every other cycle of waveform 78 to generate waveform 82, thereby allowing power flow into the constant AC voltage load 84, which represents an infinite grid.

A three phase AC grid load is accommodated as shown in FIG. 11 with three independent DC-to-AC inverter strings, each string being the same as a single phase inverter string with isolation transformers 90 added. Each string drives one of the three AC constant voltage loads that together constitute an AC three phase constant voltage load 92. Isolation transformers 90 provide galvanic isolation from the AC load 92. The DC source 94 can be three equal voltage independent DC sources as shown in FIG. 10 or the three DC source nodes can be tied together and fed by a single DC source. The filter capacitor 96 filters the 120 Hz half-sinusoidal current variation that would otherwise be present at the DC source node. The elements and operation are otherwise the same as in the circuit configuration of FIG. 10.

Those skilled in the art will appreciate that the invention is not limited to wireless power device applications. In addition to wireless inductive charging applications, the invention may also be applied to uses outside of the transportation industry such as AC induction motors, motor controllers, resonant power supplies, industrial inductive heating, melting, soldering, and case hardening equipment, welding equipment, power transformers, electronic article surveillance equipment, induction cooking appliances and stoves, other industrial equipment, and other applications incorporating plug-in charging by a plug-in charger, as well as to other non-battery charging applications such as electrochemistry, electroplating and all other loads that can be operated with a half-sinusoidal current waveform from a single phase line source, or reduced ripple waveform that results from the summation of a multiphase line source. These and other such embodiments are considered to be included within the scope of the invention as defined by the following claims.

What is claimed:

1. An intrinsic power factor correction apparatus, comprising:
an AC line source;
a line frequency rectifier connected to said AC line source to provide a half-sinusoidal rectified supply voltage;
an impedance inverter responsive to said half-sinusoidal rectified supply voltage to provide an impedance inverted secondary side voltage at an output;
a secondary side rectifier that rectifies said secondary side voltage;
a secondary side ripple filter that filters a rectified output from said secondary side rectifier to remove inverter frequency ripple and deliver a line frequency half-sinusoid current at an output; and
a load that receives said line frequency half-sinusoid current,
wherein said impedance inverter raises said secondary side voltage under conditions of light loading so as to force line frequency source current from said AC line source and said line frequency half-sinusoid current at said load to be proportional so as to maintain near unity line load power factor and low harmonic current distortion.

2. The apparatus of claim 1, wherein said impedance inverter includes a Terman Tee configuration impedance matching network and two series connected resonating capacitors having values selected such that the impedance inverter has 90 degrees of transmission phase shift that forces a load current magnitude applied to said load to be proportional and in phase with the AC line source.

3. The apparatus of claim 1, wherein said AC line source comprises a three phase AC line source, a line frequency rectifier is connected to each phase of the three phase AC line source to provide a half-sinusoidal rectified supply voltage, and a summing transformer provides galvanic isolation from the AC line source, an output of said summing transformer being provided to said impedance inverter.

4. The apparatus of claim 3, wherein said summing transformer comprises three physically independent transformers.

5. The apparatus of claim 3, wherein said summing transformer comprises a single transformer with six windings on a common core with three phase partial flux cancellation.

6. The apparatus of claim 3, further comprising filters on the three phase AC lines that reject switching frequency components of said transmission frequency inverter.

7. The apparatus of claim 3, wherein said line frequency half-sinusoid current delivered to the load is a sum of three rectified sinusoids from each AC line phase offset from each other by 120 degrees.

8. The apparatus of claim 1, wherein said AC line source comprises a three phase AC line source, a line frequency rectifier is connected to each phase of the three phase AC line source to provide a half-sinusoidal rectified supply voltage, and a primary side induction coil is implemented as three independent, co-located, induction coils sharing a common magnetic core with a secondary side induction coil that is connected to said secondary side rectifier.

9. The apparatus of claim 1, wherein the AC line source is a plug-in charger.

10. The apparatus of claim 1, wherein the load is a battery charging load.

11. The apparatus of claim 1, wherein the load is an electrochemical or electroplated load that can be operated with a half-sinusoidal current waveform from a single phase line source or a summation of a multi-phase line source.

12. An intrinsic power factor correction apparatus, comprising:
a DC power source;
a shunt ripple filter capacitor that provides line frequency ripple filtering of an output of said DC power source;
a DC-to-AC inverter that converts a line frequency ripple filtered DC voltage from an output of said shunt ripple filter capacitor to an output square wave voltage;
an impedance inverter that converts said output square wave voltage to a sinusoidal wave at a frequency of the DC-to-AC converter that is envelope modulated by a line frequency sinusoid to form a bipolar sinusoidal envelope;
a secondary side rectifier that converts the rectifies said bipolar sinusoidal envelope into a unipolar half-sinusoidal envelope;
a de-rectification network that inverts a polarity of every other cycle of the unipolar half-sinusoidal envelope to generate a sinusoidal waveform; and
an AC load that receives said sinusoidal waveform,
wherein said impedance inverter raises a secondary side voltage under conditions of light loading so as to force line frequency source current from said DC power source and a current at said AC load to be proportional so as to maintain near unity line load power factor and low harmonic current distortion.

13. The apparatus of claim 12, wherein said impedance inverter comprises a Terman impedance inverting network that provides a voltage transformation that varies with an instantaneous load voltage at the secondary side of the Terman impedance inverting network.

14. The apparatus of claim 12, further comprising a ripple filter network that removes high frequency ripple from said unipolar half-sinusoidal envelope before said unipolar half-sinusoidal envelope is applied to said de-rectification network.

15. The apparatus of claim 12, wherein said de-rectification network includes power semiconductor switches in a half wave or full wave bridge configuration.

16. The apparatus of claim 12, further comprising an isolation transformer that provides galvanic isolation between said DC power source and said AC load.

17. An apparatus comprising an intrinsic power factor correction apparatus as in claim 16 for each phase of a three phase constant voltage applied to said AC load.

18. The apparatus of claim 17, wherein said DC power source comprises three equal voltage independent DC power sources.
